(19) United States
(12) Patent Application Publication
(10) Pub. No.: US 2014/0350913 A1
(43) Pub. Date: Nov. 27, 2014

(54) TRANSLATION DEVICE AND METHOD

(71) Applicant: FUJITSU LIMITED, Kawasaki-shi (JP)

(72) Inventors: Yuchang Cheng, Kawasaki (JP); Tomoki Nagase, Kawasaki (JP)

(73) Assignee: FUJITSU LIMITED, Kawasaki-shi (JP)

(21) Appl. No.: 14/254,226

(22) Filed: Apr. 16, 2014

(30) Foreign Application Priority Data
May 23, 2013 (JP) 2013-109037

(51) Int. Cl. G06F 17/28

(52) U.S. Cl. CPC G06F 17/289
USPC 704/2

(57) ABSTRACT

A translation device includes a processor that executes a procedure. The procedure includes: generating plural original text candidates by applying each of plural predetermined different pre-editing rules or rule combinations to an original text expressed in a first language; translating each of the plural original text candidates into respective translated text candidates expressed in a second language, and translating each of the translated text candidates into a respective reverse translated text expressed in the first language; and generating a concept structure expressing a semantic structure of each of the original text candidates and each of the reverse translation texts, and selecting a translated text candidate that corresponds to the original text candidate whose degree of similarity between the concept structure of the original text candidate and the concept structure of the reverse translated text corresponding to the original text candidate is a specific value or greater.

### CROSS-REFERENCE TO RELATED APPLICATION

This application is based upon and claims the benefit of priority of the prior Japanese Patent Application No. 2013-109037, filed on May 23, 2013, the entire contents of which are incorporated herein by reference.

### FIELD

The embodiments discussed herein are related to a translation device, a translation method, and a recording medium storing a translation program.

### BACKGROUND

“Original text pre-editing” as technology for improving the translation quality of machine translation is known. Original text pre-editing is a form of revision applied to an original text prior to translation into a translation target language. For example, a subject is added when the subject is omitted in the original text, or revision is made to clarify a modification relationship when the modification relationship is unclear. Pre-editing the original text without changing the meaning in this way improves accuracy of analysis such as syntactic analysis of the original text, thereby enabling improved translation quality.

For example, technology is proposed that stores plural pre-editing rules including data that identifies application conditions and editing methods, detects a location in input text where a pre-editing rule should be applied, and applies the corresponding pre-editing rule to the detected location to pre-edit the input text. In such technology, a group of pre-editing rules corresponding to the field of the input text is selected from plural types of groups of pre-editing rules that have been categorized according to predetermined specific criteria, and the group of pre-editing rules is then applied to the input text.

### RELATED PATENT DOCUMENTS

Japanese Laid-Open Patent Publication No. H05-225232

### SUMMARY

According to an aspect of the embodiments, a translation device includes: a processor; and a memory storing instructions that, when executed by the processor, perform a procedure, the procedure including: generating plural original text candidates by applying each of plural predetermined different pre-editing rules, or rule combinations that are combinations of the pre-editing rules, to an original text expressed in a first language; translating each of the plural original text candidates into respective translated text candidates expressed in a second language different from the first language, and translating each of the translated text candidates into a respective reverse translated text expressed in the first language; and generating a concept structure expressing a semantic structure of each of the original text candidates and each of the reverse translation texts, and selecting a translated text candidate that corresponds to the original text candidate whose degree of similarity between the concept structure of the original text candidate and the concept structure of the reverse translated text corresponding to the original text candidate is a specific value or greater.

The object and advantages of the invention will be realized and attained by means of the elements and combinations particularly pointed out in the claims.

It is to be understood that both the foregoing general description and the following detailed description are exemplary and explanatory and are not restrictive of the invention.

### BRIEF DESCRIPTION OF THE DRAWINGS

FIG. 1 is a block diagram illustrating an example of a configuration of a translation device according to a first exemplary embodiment;

FIG. 2 is a diagram illustrating an example of language analysis;

FIG. 3 is a table illustrating an example of a pre-editing rule database;

FIG. 4 is a table illustrating an example of original text candidates;

FIG. 5 is a table illustrating an example of translated text candidates;

FIG. 6 is a table illustrating an example of reverse translated text;

FIG. 7 is a diagram illustrating an example of a concept structure;

FIG. 8 is a table for explaining elements of a concept structure;

FIG. 9 is a diagram for explaining concept structure similarities;

FIG. 10 is a table illustrating an example of determination results of concept structure similarity and appropriateness;

FIG. 11 is a schematic block diagram illustrating an example of a computer that functions as a translation device;

FIG. 12 is a flow chart illustrating translation processing in the first exemplary embodiment;

FIG. 13 is a flow chart illustrating selection processing in the first exemplary embodiment;

FIG. 14 is a diagram illustrating an example of concept structures;

FIG. 15 is a diagram illustrating an example of concept structures;

FIG. 16 is a diagram illustrating an example of concept structures;

FIG. 17 is a block diagram illustrating an example of a configuration of a translation device according to a second exemplary embodiment;

FIG. 18 is a flow chart illustrating pre-editing rule determination processing according to the second exemplary embodiment;

FIG. 19 is a diagram for explaining a Tree Kernel method;

FIG. 20 is a block diagram illustrating another configuration example of a machine translation section and a concept structure generating section;

FIG. 21 is a block diagram illustrating another configuration example of a machine translation section and a concept structure generation section; and

FIG. 22 is a block diagram illustrating another configuration example of a machine translation section and a concept structure generation section.

### DESCRIPTION OF EMBODIMENTS

Detailed explanation follows regarding an example of an exemplary embodiment of technology disclosed herein, with reference to the drawings.

### First Exemplary Embodiment

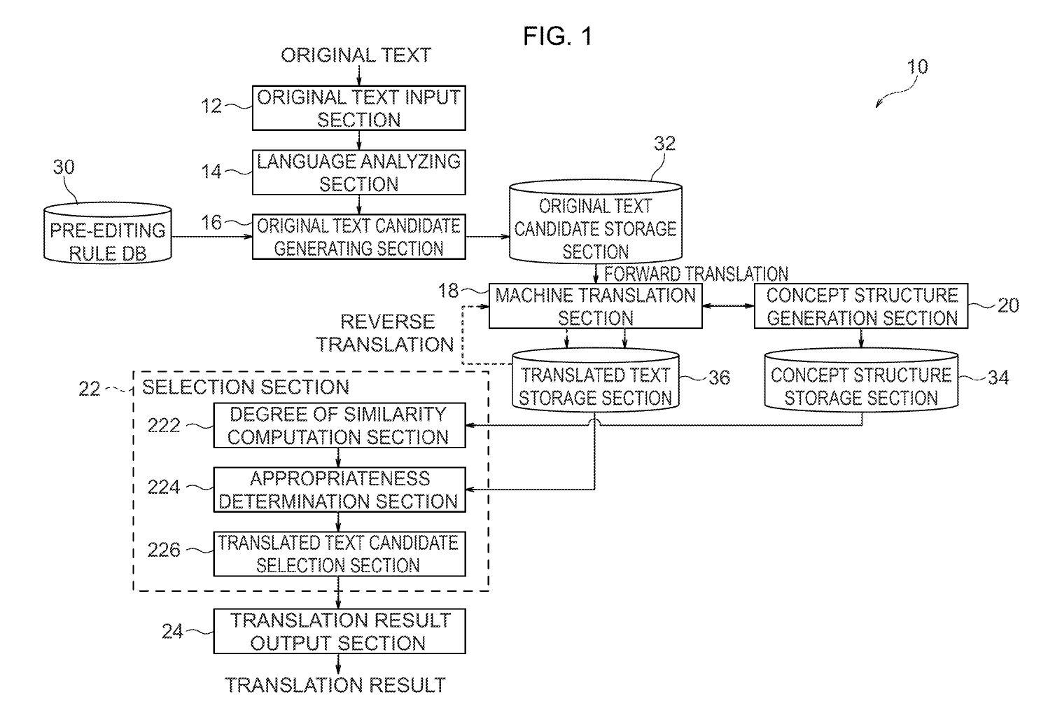

A translation device 10 according to a first exemplary embodiment is illustrated in FIG. 1. The translation device 10, as illustrated in FIG. 1, includes an original text input section 12, a language analyzing section 14, an original text candidate generating section 16, a machine translation section 18, a concept structure generation section 20, a selection section 22, and a translation result output section 24.

In the translation device 10, an original text (text data) expressed in a translation source language (first language) is input through an input device such as a keyboard connected to the translation device 10, or from a user terminal or the like connected to the translation device 10 through a network. The translation device 10 outputs a translation result (text data), of the original text translated into a translation target language (second language). Note that explanation follows in the present exemplary embodiment regarding a case in which the translation source language (first language) is Japanese, and the translation target language (second language) is English.

The original text input section 12 receives an original text input to the translation device 10 and passes the original text through to the language analyzing section 14.

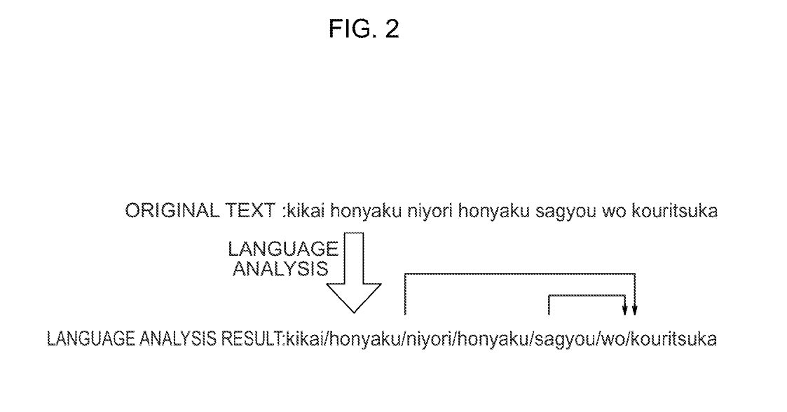

The language analyzing section 14 performs language analysis including morpheme analysis, segment analysis, modifier analysis, and semantic analysis on the original text received by the original text input section 12, and outputs language analysis results. More specifically, in the morpheme analysis, as illustrated in FIG. 2, the original text “kikai honyaku niyori honyaku sagyou wo kouritsuka” is split into word units by referencing a dictionary. Although not illustrated in FIG. 2, for each word, the word is read, and data such as part of speech and form of conjugation is appended to (associated with) the word. In segment analysis, based on the morpheme analysis, analysis is performed on the original text by segment units by processing, such as processing to group nouns and postpositions (particles) into one. In the modifier analysis, based on the morpheme analysis results and the segment analysis results, the modification relation of the segments are analyzed according to rules. In semantic analysis, based on the modifier analysis results, appropriate modification relations are identified by determining the relationships between modifiers and modificands according to rules.

The language analyzing section 14 may, based on each of the analysis results, generate a concept structure of the original text (described in detail later). Note that as original text language analysis, the language analyzing section 14 does not necessarily perform all of morpheme analysis, segment analysis, modifier analysis, semantic analysis, and concept structure generation, and required analysis may be performed at the time of application of pre-editing rules by the original text candidate generating section 16, as described later.

The original text candidate generating section 16, based on the language analysis results output from the language analyzing section 14, references a pre-editing rule database (DB) 30, and applies each of the applicable pre-editing rules to the original text, and generates plural original text candidates.

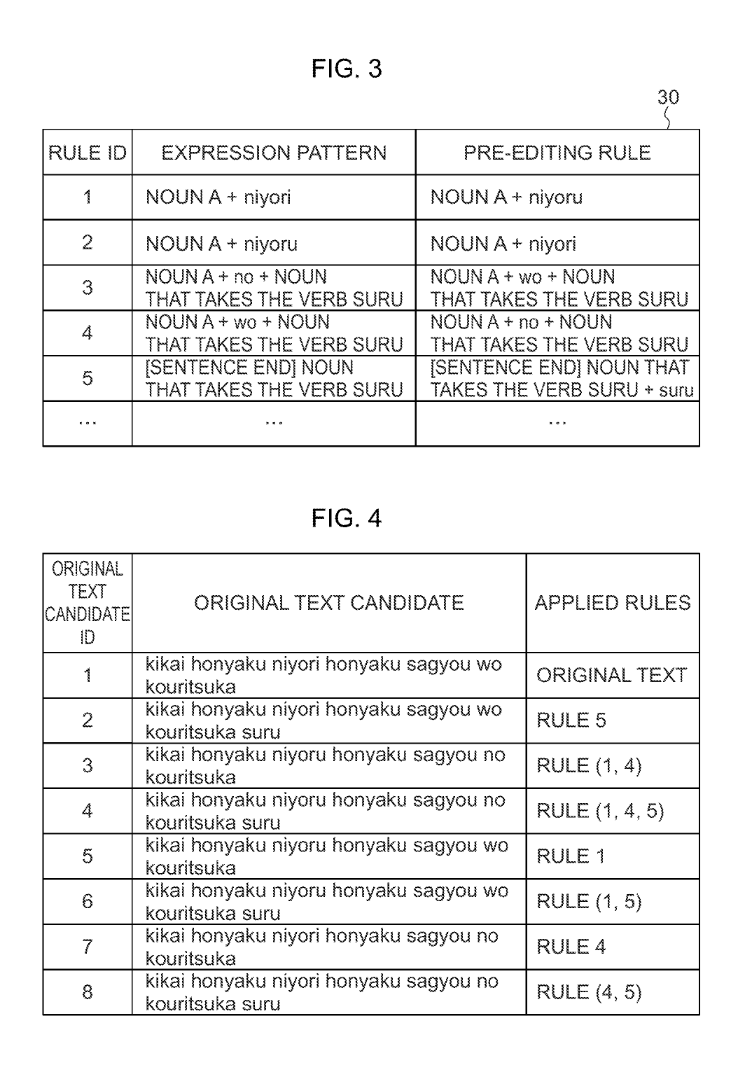

As illustrated in FIG. 3, in the pre-editing rule DB 30, for example expression patterns identifiable from the language analysis results are respectively associated with pre-editing rules that determine how to convert locations in the original text corresponding to the expression patterns. Expression patterns identifiable from the language analysis results are patterns expressed using the characteristics of each of the analysis results. For example, the example in FIG. 3 illustrates an expression pattern expressed by characteristics such as part of speech and notation of morpheme included in the morpheme analysis results. A rule ID that is an identification number of each pre-editing rule is appended to each of the pre-editing rules. In the following, the rule with rule ID 1 is referred to as “rule 1”. Similar applies to other rule IDs.

Each of the pre-editing rules has a recognition target of a partial expression pattern expressed in the original text, and consider need not be given to such factors as the structure, meaning and context of the text as a whole. Namely, there is no need for example for specialist knowledge of the original text and of the translation target language, or for knowledge to improve the translation quality of machine translation. Moreover, all sorts of rules may be defined and set without considering the influence of pre-editing on the translation result. Note that in the present exemplary embodiment, explanation is given of a case in which an expression pattern is identifiable from the language analysis results, however pre-editing rules not based on the language analysis results may be defined and set. For example, when defining and setting as expression patterns only simple, partial notations such as “niyori {by using}”, “no {of}”, “wo {direct object particle}”, a pre-editing rule may be defined and set that converts these partial notation portions into another notation. Moreover, irrespective of the expression pattern, a pre-editing rule may be defined and set to add a subject such as “watashi ha {I, with topic marker}” at the beginning of a sentence, or a pre-editing rule may be defined and set to add a predicate such as “suru {to make}” at the end of a sentence.

The original text candidate generating section 16 compares each of the pre-editing rules stored in the pre-editing rule DB 30 against the language analysis results, and recognizes locations in the original text that match expression patterns included in the pre-editing rule DB 30. Locations matched to a given expression pattern are converted according to the pre-editing rule corresponding to that expression pattern. When the original text includes a location that matches plural expression patterns, then the plural corresponding pre-editing rules are applied. When in the following, plural pre-editing rules are applied to the original text, the plural pre-editing rules will be referred to as a “rule combination”, notated for example as rule (1, 4). Rule (1, 4) denotes a rule combination of rule 1 and rule 4.

For example, when the original text is “kikai honyaku {machine translation} niyori {by using} honyaku sagyou {translation work} wo kouritsuka {efficiency improvement}”, then with reference to the pre-editing rule DB 30 of FIG. 3, the location “kikai honyaku niyori” matches an expression pattern “noun A+niyori” corresponding to rule 1. When this location is converted according to the pre-editing rule of rule 1 “noun A+niyoru”, an original text candidate is generated of “kikai honyaku niyoru honyaku sagyou wo kouritsuka”. Moreover, the location “ . . . kouritsuka” in the same original text matches the expression pattern “[sentence end] noun that takes the verb suru” corresponding to rule 5. When this location is converted according to the pre-editing rule of rule 5 “[sentence end] noun that takes the verb suru+suru”, then an original text candidate is generated of “kikai honyaku niyori honyaku sagyou wo kouritsuka suru”. Moreover, when the rule combination (1, 5) is applied, the original text candidate of “kikai honyaku niyoru honyaku sagyou wo kouritsuka suru” is generated. Plural original text candidates are thereby generated by applying each of the pre-editing rules and rule combinations corresponding to the expression patterns that match. The generated original text candidates are stored in an original text candidate storage section 32.

An example of original text candidates generated in the original text candidate generating section 16 is illustrated in FIG. 4. In FIG. 4, the rule IDs of the pre-editing rules and rule combinations applied when generating the original text candidates are denoted alongside the original text candidates. Original text candidate IDs that are identification numbers for each of the original text candidates are appended to each of the original text candidates when storing the generated original text candidates in the original text candidate storage section 32. Note that the an original text candidate with an original text candidate ID of 1 (referred to below as “original text candidate 1”, other original text candidate IDs are referred to similarly) indicates a state in which the original text is left unaltered, without performing pre-editing. The reason the original text is left in an unaltered state as the original text candidate is in consideration of the point that sometimes a better quality translation result is obtained by leaving the original text unaltered.

The machine translation section 18 performs machine translation on each of the original text candidates stored in the original text candidate storage section 32, and generates translated text candidates that are Japanese language original text candidates translated into English. Such translation from the original text language (first language, in this case Japanese) to the translation target language (second language, in this case English) is called “forward translation”. More specifically, the machine translation section 18, similarly to the language analyzing section 14, performs morpheme analysis, segment analysis, modifier analysis, and semantic analysis on each of the original text candidates, and passes each of the analysis results to the concept structure generation section 20.

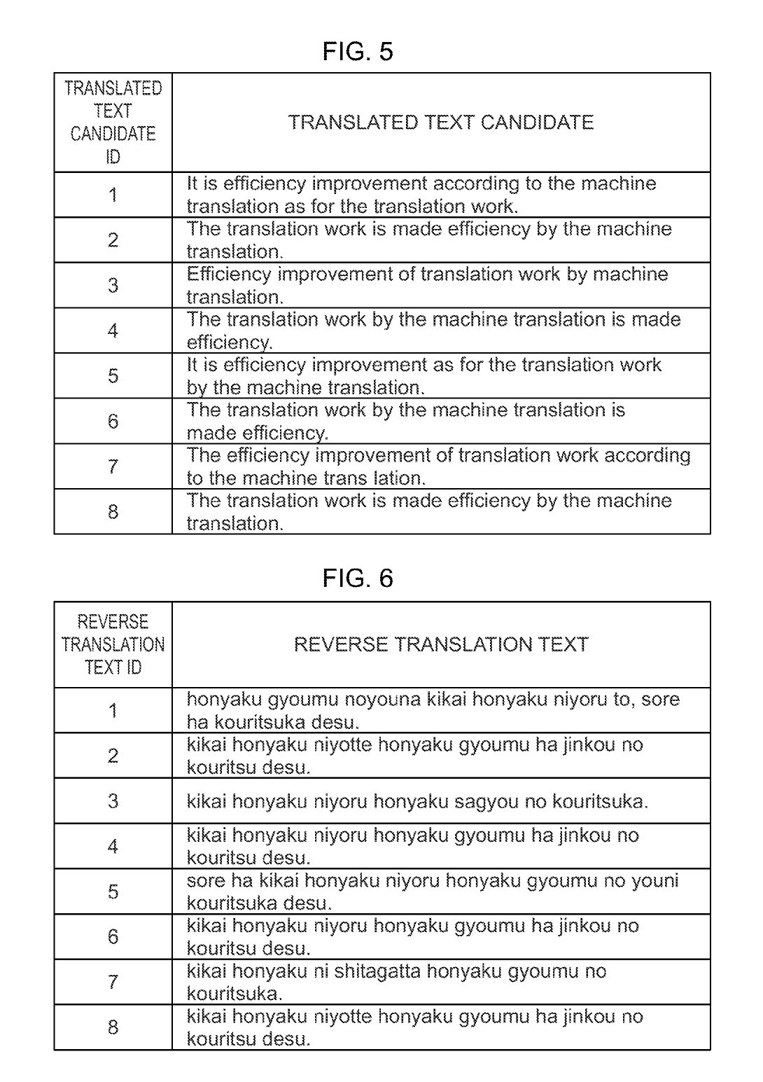

The machine translation section 18 then receives each of the concept structures (described in detail later) of the original text candidates generated in the concept structure generation section 20, and then generates respective translated text candidates based on the concept structure of each of the original text candidates. Specifically, the concepts expressed by each of the elements contained in the concept structure of the original text candidates are converted into English words, and then an English sentence is assembled from the concept structures according to English syntactic analysis. Each of the translated text candidates corresponding to the respective original text candidate is generated in this manner. The machine translation section 18 stores each of the generated translated text candidates in a translated text storage section 36. An example of the translated text candidates generated in the machine translation section 18 is illustrated in FIG. 5. A translated text candidate ID that is an identification number of each of the translated text candidates and also corresponds to the original text candidate ID is appended to each of the translated text candidates when storing the generated translated text candidates in the translated text storage section 36. Note that the translated text candidate with a translated text candidate ID of 1 is referred to below as “translated text candidate 1”. Other translated text candidate IDs are referred to similarly.

The machine translation section 18 performs machine translation on each of the translated text candidates stored in the translated text storage section 36, generating reverse translated text of the English translated text candidates translated into Japanese. Such translation from the translation target language (second language, in this case English) into the original text language (first language, in this case Japanese) is called “reverse translation”. More specifically, the machine translation section 18, similarly to the language analyzing section 14, performs morpheme analysis, segment analysis, modifier analysis, and semantic analysis on each of the translated text candidates, and then passes each of the analysis results to the concept structure generation section 20.

The machine translation section 18 then receives each of the concept structures (described in detail later) of the reverse translated texts generated by the concept structure generation section 20, and then generates respective reverse translated texts based on the concept structure of each of the reverse translated texts. Specifically, concepts expressed by each of the elements contained in the concept structure of the reverse translated texts are converted into Japanese words, and then a Japanese sentence is assembled from the concept structures according to Japanese syntactic analysis. Each of the reverse translated texts corresponding to the respective translated text candidates, namely corresponding to each of the original text candidates, is generated in this manner. The machine translation section 18 stores each of the generated reverse translated texts in the translated text storage section 36. An example of the reverse translated texts generated in the machine translation section 18 is illustrated in FIG. 6. A reverse translated text ID that is an identification number of each of the reverse translated texts and also corresponds to the original text candidate ID is appended to each of the reverse translated texts when storing the generated reverse translated texts in the translated text storage section 36. Note that the reverse translated text with a reverse translated text ID of 1 is referred to below as “reverse translated text 1”. Other reverse translated text candidate IDs are referred to similarly.

The concept structure generation section 20 determines the syntactic relationship between segments based on each of the analysis results of the original text candidates received from the machine translation section 18, generates concept structures for each of the original text candidates, and both stores the generated concept structures in a concept structure storage section 34 and passes the generated concept structures to the machine translation section 18. The concept structure generation section 20 also generates respective concept structures of the translated text candidates (similar values to the concept structures of the reverse translated texts) based on the analysis results of each of the translated text candidates received from the machine translation section 18, and both stores the generated concept structures in the concept structure storage section 34 and passes the concept structures to the machine translation section 18.

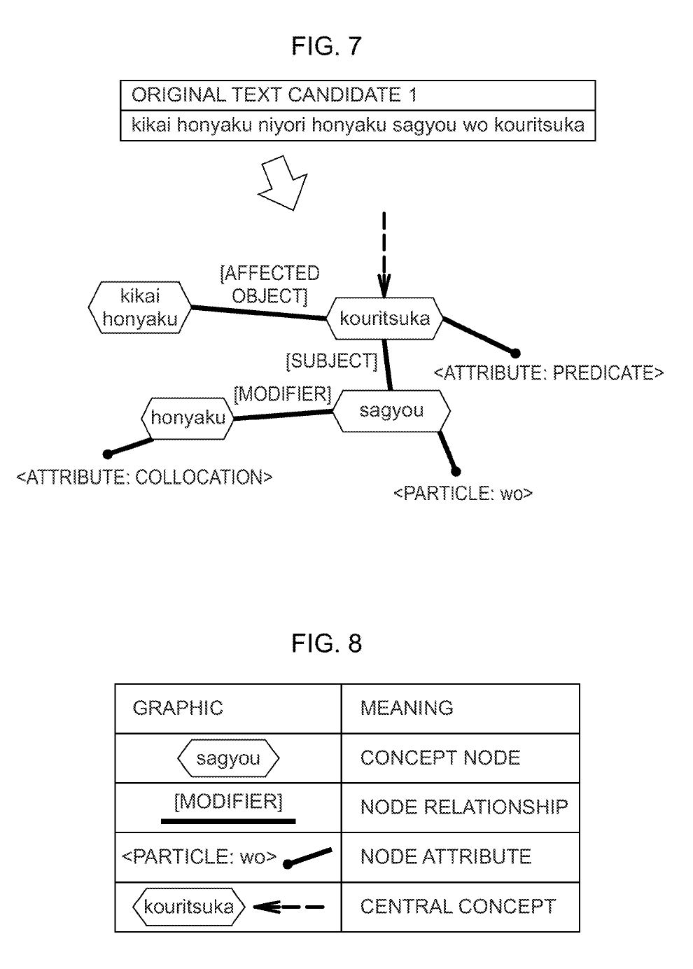

The concept structure referred to here is one derived by making the semantics of the text into a structure, and is a non-language dependent expression form of the semantic structure in which the influence of for example word order, notation variation, perfect synonyms, and imperfect synonyms has been suppressed to a minimum. The concept structure may, for example, be expressed as illustrated in FIG. 7. FIG. 7 is an example of the concept structure of the original text candidate 1. Examples of graphics and semantics for each of the elements included in the concept structure are illustrated in FIG. 8. As illustrated in FIG. 8, the concept structure includes as elements a concept node, a node relationship, a node attribute, and a central concept. Note that in the example of FIG. 7, for the purposes of explanation each of the elements is expressed in written Japanese (English in this translated specification), however in practice non-language dependent values expressing the concept are appended to each of the elements. Accordingly elements with similar concepts have similar values in the original text language and the translation target language.

The concept node expresses each of the words (independent words) included in text that have a concept (meaning) as a concept common between languages. The example of FIG. 7 includes concept nodes of “kikai honyaku”, “kouritsuka”, “honyaku {translation}”, and “sagyou {work}”. Namely, the concept structure of FIG. 7 expresses that the original text candidate 1 includes words with the concepts of “kikai honyaku”, “kouritsuka”, “honyaku”, and “sagyou”.

The node relationship connects between concept nodes that have a semantic relationship and expresses the type of relationship between connected concept nodes. In the example of FIG. 7 the concept node “kikai honyaku” is the [affected object] of the concept node “kouritsuka”. It is also illustrated that the concept node “sagyou” is the [subject] of the concept node “kouritsuka”. It is also illustrates that the concept node “honyaku” has a relationship of being the [modifier] of concept node “sagyou”.

The node attribute indicates a particle that belongs to the concept node and the grammatical attribute of the concept node itself. The example of FIG. 7 illustrates that the concept node “kouritsuka” has the attribute of <predicate>. It moreover illustrates that the particle <wo>belongs to the concept node “sagyou”. It also illustrates that the concept node “honyaku” has an attribute of <collocation>.

The central concept is the most important concept node that dominates the meaning of the sentence overall, and is a concept node that does not appear at an end point of a node relationship. In the example of FIG. 7, the relationship between the concept node “kouritsuka” and the concept node “kikai honyaku” considers what sort of relationship there is between the both concept nodes, and is expressed by an arrow from the concept node “kouritsuka” towards the concept node “kikai honyaku”. Namely, the concept node “kouritsuka” is the start point and the concept node “kikai honyaku” is the end point. Thus by looking at the relationship between each of the concept nodes in this manner, it is seen that the concept node “kouritsuka” is the central concept since the concept node “kouritsuka” is the start point of every node relationship, and is never the end point. There is a single central concept present in a concept structure. Note that in the example illustrated in FIG. 7, the fact that the concept node that is the central concept is not an end point in a node relationship is illustrated by an intermittent arrow that has nothing present at its start point.

The selection section 22 selects an appropriate translated text candidate as an original text translation result from out of the translated text candidates stored in the translated text storage section 36. The selection section 22 includes a degree of similarity computation section 222, an appropriateness determination section 224, and a translated text candidate selection section 226.

The degree of similarity computation section 222 computes a concept structure similarity that indicates the degree of similarity between the concept structure of each of the original text candidates stored in the concept structure storage section 34, and the concept structure of the reverse translated texts corresponding to the original text candidates.

Explanation next follows regarding reasoning behind employing the degree of similarity between the original text candidate concept structures and the reverse translated text concept structures to select the appropriate translated text candidate as the translation result.

First, the original text candidate 1 is compared to the translated text candidate 1 and the reverse translated text 1 that corresponds to the original text candidate 1.

Original text candidate 1: kikai honyaku niyori honyaku sagyou wo kouritsuka Translated text candidate 1: It is efficiency improvement according to the machine translation as for the translation work.
Reverse translated text 1: honyaku gyoumu {translation business} noyouna {-like} kikai honyaku {machine translation} niyoru to {according to}, sore {that} ha {topic marker particle} kouritsuka desu {efficiency+to be}.
In the above example, accurate Japanese language analysis is unable to be performed during forward translation due to inappropriate parts in the grammar of the original text candidate 1 (the unaltered original text). The translated text candidate 1, that is the translation result of forward translation based on the language analysis result of the deficient Japanese, does not have good translation quality. It is seen that the translation quality of the translated text candidate 1 is low by the distance in meaning of the reverse translated text 1 reverse translated from the translated text candidate 1 and the original text candidate 1.

Comparison is then made between the original text candidate 7 that is the pre-edited original text, and the translated text candidate 7 and the reverse translated text 7 corresponding to the original text candidate 7. Note that in the original text candidate locations where pre-editing rules have been applied are indicated by [ ]. Original text candidate 7: kikai honyaku niyori honyaku sagyou [no] kouritsuka

Translated text candidate 7: The efficiency improvement of the translation work according to the machine translation.
Reverse translated text 7: kikai honyaku ni {a preposition particle} shitagatta [according to] honyaku gyoumu no kouritsuka.
In the example described above, it is seen that the translation quality of the translated text candidate 7 is high by the closeness in meaning of the reverse translated text 7 reverse translated from the translated text candidate 7 and the original text candidate 7. Namely, the original text candidate 7 is an original text candidate generated by application of an appropriate pre-editing rule to the original text.

Moreover, as an another example, a comparison is made between the original text candidate 2 pre-edited from the original text, the translated text candidate 2 and the reverse translated text 2 corresponding to the original text candidate 2.

Original text candidate 2: kikai honyaku niyori honyaku sagyou wo kouritsuka [sura].
Translated text candidate 2: The translation work is made efficiency by the machine translation.
Reverse translated text 2: kikai honyaku niyotte honyaku gyoumu ha jinkou [man-made] no kouritsu desu.
In the example described above, it is seen that the translation quality of the translated text candidate 2 is low by the distance in meaning between the reverse translated text 2, that has been reverse translated from the translated text candidate 2, and the original text candidate 2. Namely, the original text candidate 2 is an original text candidate generated by application of inappropriate pre-editing of the original text.

As described above, the translation quality of a translated text candidate is confirmed by the closeness or distance in meaning between the original text candidate and the reverse translated text. There is a high degree of similarity between the original text candidate concept structure and the reverse translated text concept structure when the meanings of the original text candidate and the reverse translated text are close to each other. However, there is a low degree of similarity between the original text candidate concept structure and the reverse translated text concept structure when the meanings of the original text candidate and the reverse translated text are distant from each other. Namely, the original text candidate that generates the best translation result is identified by comparing the concept structure of the original text candidate at forward translation and the concept structure of the reverse translated text at reverse translation. Identification of the original text candidate that generates the best translation result means identification of the original text candidate generated by application of the most appropriate pre-editing rule.

In order to determine the closeness or distance in meanings between the original text candidate and the reverse translated text, more appropriate determination is made by comparing the concept structures with each other than by employing notation and word order to compare the original text candidate and the reverse translated text. Explanation thereof follows using an example sentence.

Original text candidate: kore ha kinou watashi ga tsukutta keisanki da.
Translated text candidate: This is a computer that I made yesterday.
Reverse translated text: kore ha, watashi ga kinou tsukutta konpyu-ta desu.

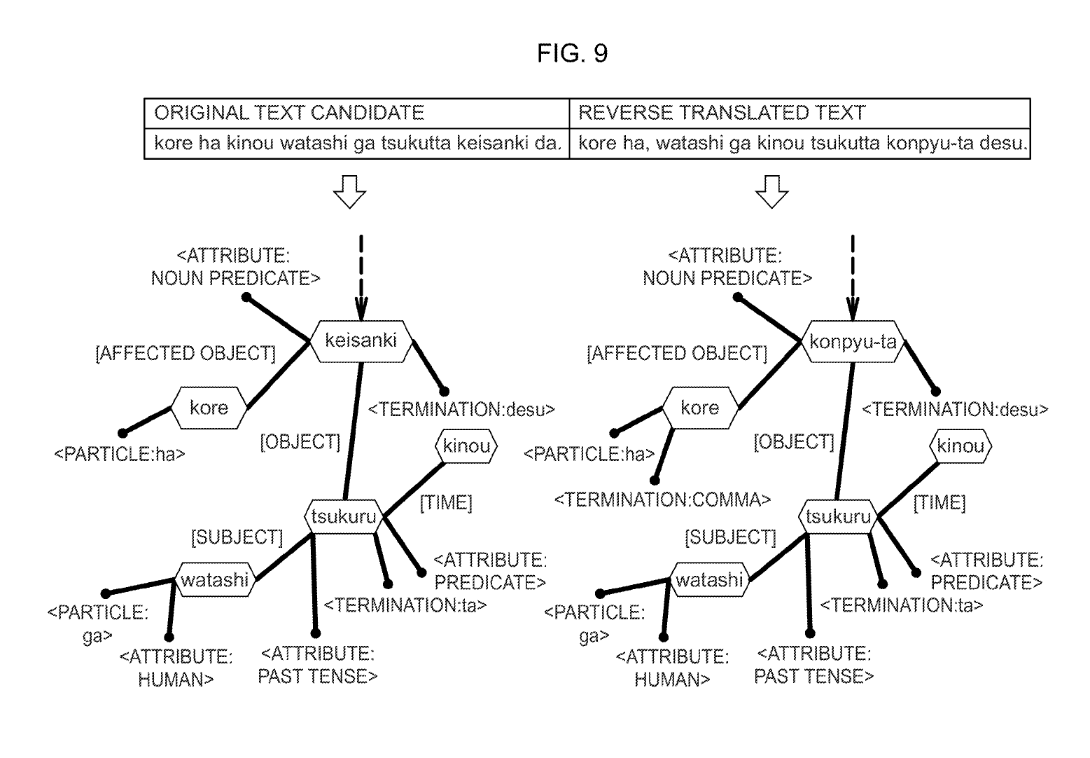

Comparing the original text candidate and the reverse translated text indicates the presence of: a change in word order (original text candidate “kinou watashi ga”→reverse translated text “watashi ga kinou”; a substitution of a word similar in meaning (original text candidate “keisanki da”→reverse translated text “konpyu-ta desu”), and a change in sentence structure (original text candidate “kore ha”→reverse translated text “kore ha,”. The original text candidate and the reverse translated text accordingly appear distant from each other in terms of notation. However, as illustrated in FIG. 9, it is seen from a comparison of the concept structures of the two texts that they substantially match each other. Accordingly a more accurate evaluation is made of the degree of similarity between the original text candidate and the reverse translated text in the above example by comparing the concept structures that express the semantic structure, than by comparing the notation and word order thereof. Note that in FIG. 9, the concept node “keisanki” and the concept node “konpyu-ta” have similar values as concepts.

Due to reasoning such as described above, the degree of similarity computation section 222 computes the concept structure similarity between the original text candidate concept structure and the reverse translation text concept structure. Specifically, a structure score indicating a structure of the concept structures and a difference score indicating the difference in concept structures is computed for each of the original text candidates and their respective corresponding reverse translated texts (referred to below as “original text candidate—reverse translated text pairs”). The concept structure similarity is then computed from the structure score and the difference score.

More specifically, the degree of similarity computation section 222, gives scores as indicated below according to the type of each of the elements contained in the concept structure, for example.
score for central concept: α
score for concept nodes other than the central concept: β
score for node relationship: γ
score for node attribute: δ

The values of α, β, γ, and δ may be set in consideration of the importance of each of the elements in the concept structure, such as for example, α>β>γ>δ. Namely, the central concept may be set with the greatest weighting since it is the most important concept node, followed in order of increasing weighting by the concept nodes other than the central concept, then the node relationships, and the node attributes. Note that setting of these scores may be made so as to be settable as appropriate to the field of application of the machine translation device. For example, the value of α may be set larger in cases in which emphasis is placed on maintaining the meaning of important portions of a sentence between the original text and the translation result, and the value of β may be set larger in cases in which emphasis is placed on maintaining the overall meaning of the sentence between the original text and the translation result.

Next, the following values are computed from each of the elements respectively included in the original text candidate concept structure and the reverse translation text concept structure.
number of concept nodes other than the central concept included in both concept structures: X
number of node relationships included in both concept structures: Y
number of node attributes included in both concept structures: Z
difference of central concept between concept structures: R
   For example, in cases in which the central concepts match each other, R=0, and when they are different R=1
number of concept nodes that differ between concept structures: X′
   For example, a concept node that differs is a concept node that is only present on one of the concept structures. The position of the concept node and the relationship between concept nodes is not considered.
number of node relationships that differ between concept structures: Y′
   For example, a node relationship that differs is a node relationship in which the type of node relationship or the concept node to which the node relationship is connected is different.
number of node attributes that differ between concept structures: Z′
   For example, a node attribute that differs is a node attribute of a different type or a node attribute belonging a different concept node.

Each of the scores and each of the values described above are employed in the following manner to compute the respective structure scores of the concept structures and the difference scores between the concept structures, and the concept structure similarities are computed from the structure scores and the difference scores.

Structure scores of the concept structures=α*2+β*X+γ*Y+δ*Z

Difference scores between concept structures=α*R+β*X′+y*Y′+δ*Z′Concept structure similarity=(structure score of concept structures−difference score between concept structures)/(structure score of concept structures)

The appropriateness determination section 224 compares the notation of the original text candidate with the notation of the reverse translated text for each of the original text candidate—reverse translated text pairs, and determines the appropriateness of the translated text candidate corresponding to the original text candidate—reverse translated text pair as a translation result. When there is a large difference between notation even though there is a similarity in concept structure between the original text candidate and the reverse translated text, the translated text candidate corresponding to this original text candidate—reverse translated text pair is sometimes determined not to be appropriate as a translation result. The appropriateness determination section 224, for example, computes the notation similarity for each of the original text candidate—reverse translated text pairs using the following data.
character unit edit distance between the original text candidate and the reverse translated text: D1
morpheme unit edit distance between original text candidate and the reverse translated text: D2
notation length of original text candidate: L1
notation length of reverse translated text: L2
morpheme string length of original text candidate: M1
morpheme string length of reverse translated text: M2
   Notation similarity=(D1/(L1+L2))+(D2/(M1+M2))

When the notation similarity computed as described above for the original text candidate—reverse translated text pair is higher than a predetermined threshold value, the appropriateness determination section 224 determines that the translated text candidate corresponding to this original text candidate—reverse translated text pair is appropriate. However, when the notation similarity is a predetermined threshold value or lower, the appropriateness determination section 224 determines that the translated text candidate corresponding to this original text candidate—reverse translated text pair is not appropriate. The threshold value is an appropriate value determined by learning using a for example translation corpus.

Based on the concept structure similarity of each of the original text candidate—reverse translated text pairs computed by the degree of similarity computation section 222, and based on the appropriateness determination results determined by the appropriateness determination section 224, the translated text candidate selection section 226 selects from out of plural translated text candidates a translated text candidate to output as a translation result. For example, the translated text candidate corresponding to the original text candidate—reverse translated text pair with the greatest concept structure similarity computed by the degree of similarity computation section 222 may be selected from out of the translated text candidates determined to be appropriate by the appropriateness determination section 224.

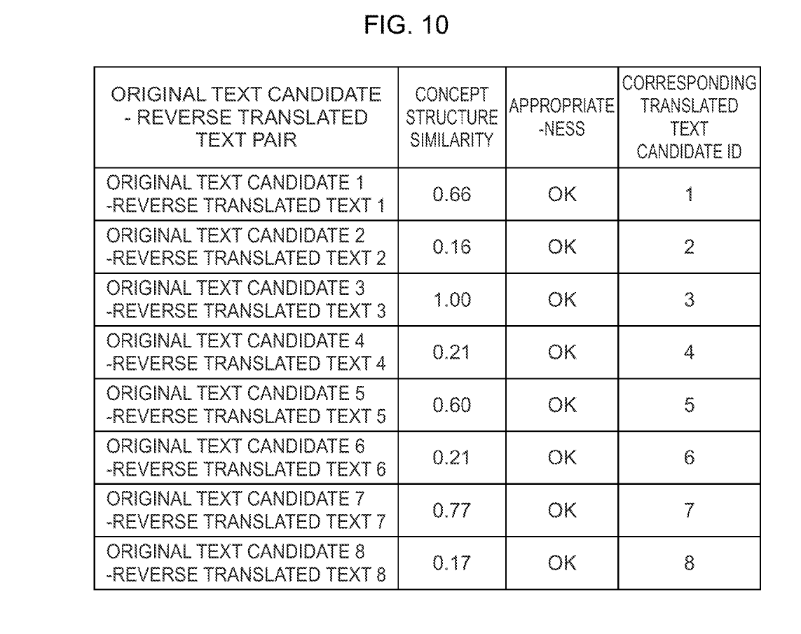

FIG. 10 illustrates examples of concept structure similarity computed by the degree of similarity computation section 222 and appropriateness determined by the appropriateness determination section 224. In the example of FIG. 10, the appropriateness is indicated as “OK” when appropriate and indicated as “NG” when inappropriate (there are no instances of “NG” in FIG. 10). In the example of FIG. 10, the appropriateness of all the original text candidate—reverse translated text pairs is “OK (appropriate)”, and so the translated text candidate 3 corresponding to the original text candidate 3—reverse translated text 3 pair that has the greatest concept structure similarity is selected from therein.

Note that there is not necessarily one translated text candidate that is selected. For example, the translated text candidates corresponding to all the original text candidate—reverse translated text pairs having a concept structure similarity of a specific value or greater may be selected. Alternatively a specific number of the translated text candidates corresponding to the original text candidate—reverse translated text pairs with the highest concept structure similarities may be selected.

The translation result output section 24 outputs the translated text candidate selected in the selection section 22 as the translation result for the original text. When plural translated text candidates are selected by the selection section 22, the order may be rearranged into sequence starting from the highest concept structure similarity of the original text candidate—reverse translated text pairs corresponding to the translated text candidates, and the translated text candidates output. Moreover, the translated text candidates may be appended with corresponding concept structure similarity and appropriateness determination results and output.

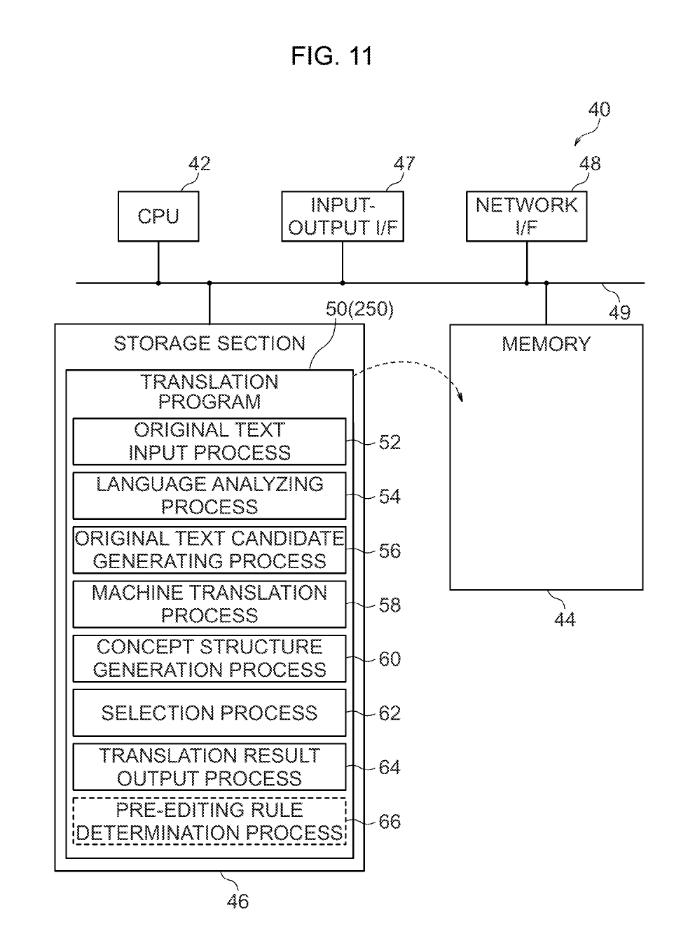

The translation device 10 may be implemented by a computer 40, such as for example that illustrated in FIG. 11. The computer 40 includes a CPU 42, a memory 44, a non-volatile storage section 46, an input-output interface (I/F) 47, and a network I/F 48. The CPU 42, the memory 44, the storage section 46, the input-output I/F 47, and the network I/F 48 are connected together through a bus 49.

The storage section 46 that serves as a storage medium may be implemented for example by a Hard Disk Drive (HDD) or by flash memory. A translation program 50 that causes the computer 40 function as the translation device 10 is stored in the storage section 46. The CPU 42 reads the translation program 50 from the storage section 46, expands the translation program 50 into the memory 44, and sequentially executes processes of the translation program 50.

The translation program 50 includes an original text input process 52, a language analyzing process 54, an original text candidate generating process 56, a machine translation process 58, a concept structure generation process 60, a selection process 62, and a translation result output process 64.

The CPU 42 operates as the original text input section 12 illustrated in FIG. 1 by executing the original text input process 52. The CPU 42 operates as the language analyzing section 14 illustrated in FIG. 1 by executing the language analyzing process 54. The CPU 42 operates as the original text candidate generating section 16 illustrated in FIG. 1 by executing the original text candidate generating process 56. The CPU 42 operates as the machine translation section 18 illustrated in FIG. 1 by executing the machine translation process 58. The CPU 42 operates as the concept structure generation section 20 illustrated in FIG. 1 by executing the concept structure generation process 60. The CPU 42 operates as the selection section 22 illustrated in FIG. 1 by executing the selection process 62. The CPU 42 operates as the translation result output section 24 illustrated in FIG. 1 by executing the translation result output process 64. The computer 40 executing the translation program 50 accordingly functions as the translation device 10.

Note that it is possible to implement the translation device 10 with, for example, a semiconductor integrated circuit, and more particularly with an Application Specific Integrated Circuit) ASIC or the like.

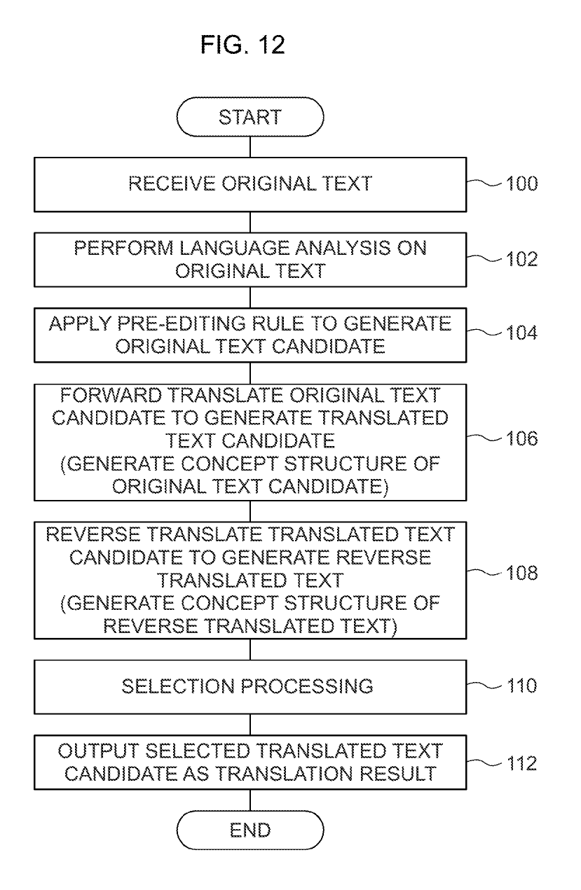

Explanation next follows regarding operation of the translation device 10 according to the present exemplary embodiment. On input of the original text (text data) in the translation source language (first language, in this case Japanese) to the translation device 10, the translation processing illustrated in FIG. 12 is executed by the translation device 10.

At step 100 of the translation processing illustrated in FIG. 12, the original text input section 12 receives the input original text. In this case, for example as illustrated in FIG. 2, original text “kikai honyaku niyori honyaku sagyou wo kouritsuka” is received. Then at step 102, as illustrated in FIG. 2, the language analyzing section 14 performs language analysis on the original text received at step 100, including morpheme analysis, segment analysis, modifier analysis, and semantic analysis.

Then at step 104, based on the language analysis results of step 102, the original text candidate generating section 16 refers to the pre-editing rule DB 30 as illustrated in FIG. 3, applies applicable pre-editing rules or rule combinations to the original text and generates plural original text candidates. The original text candidate generating section 16 stores the plural generated original text candidates in the original text candidate storage section 32. In this case, for example, the original text candidate 1 to original text candidate 8 as illustrated in FIG. 4 are generated.

Then at step 106, the machine translation section 18 performs machine translation on each of the original text candidates stored in the original text candidate storage section 32, and generates respective translated text candidates that have been forward translated from Japanese to English. In this case, for example, the translated text candidate 1 to translated text candidate 8 as illustrated in FIG. 4 are generated. The machine translation section 18 stores each of the generated translated text candidates in the translated text storage section 36. During forward translation, the concept structure generation section 20 generates the concept structures for the respective original text candidates, and stores these in the concept structure storage section 34.

Then at step 108, the machine translation section 18 performs machine translation on each of the translated text candidates stored in the translated text storage section 36, and generates respective reverse translation texts that have been reverse translated from English to Japanese. In this case, for example, the reverse translation text 1 to reverse translation text 8 as illustrated in FIG. 6 are generated. The machine translation section 18 stores each of the generated reverse translation texts in the translated text storage section 36. Moreover, during reverse translation, the concept structure generation section 20 generates the concept structure for each of the reverse translated texts, and stores these in the concept structure storage section 34.

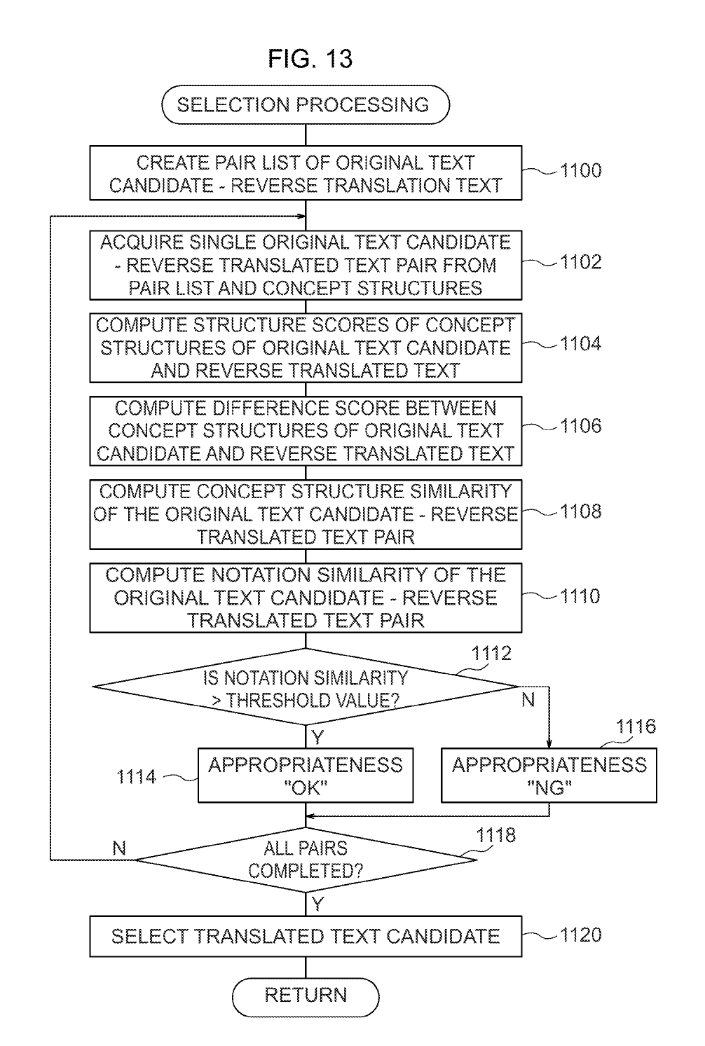

Then at step 110, the selection section 22 executes the selection processing illustrated in FIG. 13.

At step 1100 of the selection processing illustrated in FIG. 13, the degree of similarity computation section 222 creates a pair list that associates respective original text candidates stored in the original text candidate storage section 32 with respective reverse translation texts stored in the translated text storage section 36. For example, a pair list such as original text candidate 1—reverse translated text 1, original text candidate 2—reverse translated text 2, and so on up to original text candidate 8—reverse translation text 8 is created.

Then at step 1102, the degree of similarity computation section 222 acquires a single original text candidate—reverse translated text pair from the list created at step 1100. The degree of similarity computation section 222 also acquires the respective concept structures of the original text candidate and the reverse translated text included in the acquired pair from the concept structure storage section 34.

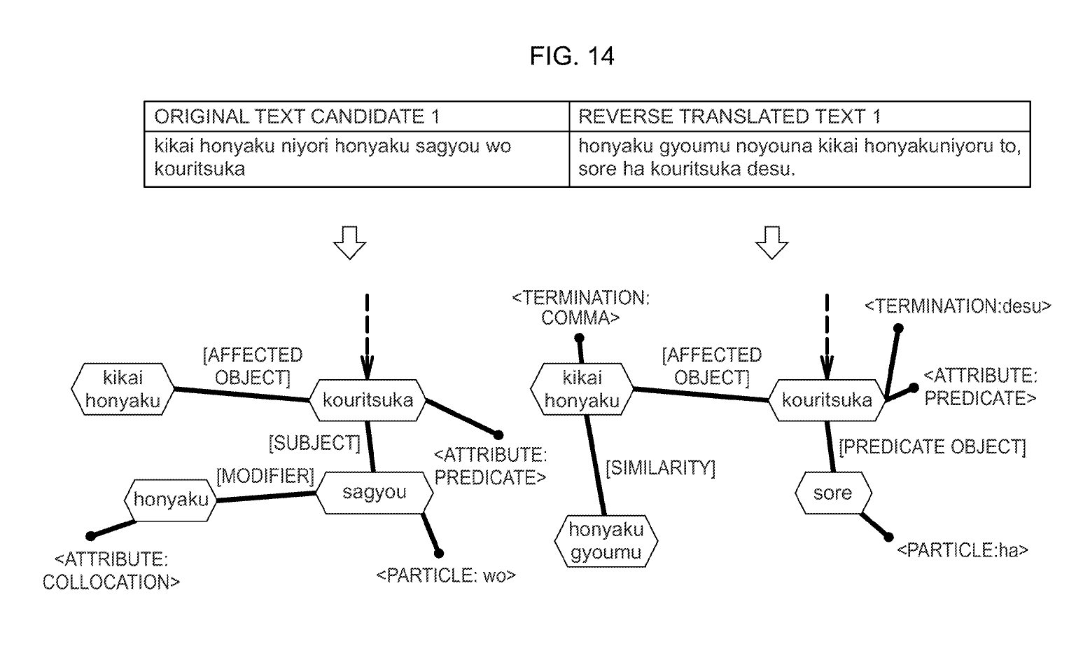

Then at step 1104, the degree of similarity computation section 222 computes structure scores of the original text candidate concept structure and the reverse translated text concept structure acquired at step 1102. For example, when the original text candidate—reverse translated text pair acquired at step 1102 is the original text candidate 1—reverse translation text 1, the structure scores for the respective concept structures such as those illustrated in FIG. 14 are computed and summed to compute the structure score of the concept structures. When the concept structure similarity computation example described above is employed, the structure score of the concept structures of the original text candidate 1—reverse translated text 1 is computed as follows. Note that explanation follows for a case in which α=50, β=10, γ=5 and δ=2.
number of concept nodes other than the central concept included in the concept structure of the original text candidate 1: 3
(“kikai honyaku”, “honyaku”, and “sagyou”)
number of concept nodes other than the central concept included in the concept structure of the reverse translated text 1: 3
(“kikai honyaku”, “honyaku gyoumu”, and “sore”)
number of concept nodes other than the central concept included in the both concept structures: X=6
number of node relationships included in the concept structure of the original text candidate 1: 3
   ([affected object] between “kikai honyaku” and “kouritsuka”, [subject] between “kouritsuka” and “sagyou”, and [modifier] between “honyaku” and “sagyou”)
number of node relationships included in the concept structure of the reverse translated text 1: 3
   ([affected object] between “kikai honyaku” and “kouritsuka”, [predicate object] between “kouritsuka” and “sore”, [similarity] between “kikai honyaku” and “honyaku gyoumu”.
number of node relationships included in the both concept structures: Y=6
number of node attributes included in the concept structure of the original text candidate 1: 3
   (<attribute: predicate>belonging to “kouritsuka”, <particle: wo>belonging to “sagyou”, and <attribute: collocation>belonging to “honyaku”)
number of node attributes included in the concept structure of the reverse translated text 1: 4
   (<attribute: predicate>belonging to “kouritsuka”, <termination: desu) belonging to “kouritsuka”, <termination: comma>belonging to “kikai honyaku”, <particle: ha>belonging to “sore”>
number of node attributes included in the both concept structures: Z=7

$$Structure score of concept structure = α * 2 + β * X + γ * Y + δ * Z = 50 * 2 + 10 * 6 + 5 * 6 + 2 * 7 = 204$$

Then at step 1106, the degree of similarity computation section 222 computes the difference score between the concept structures. The difference between the original text candidate 1—reverse translated text 1 pair illustrated in FIG. 14 is computed as follows.
difference of central concept between concept structures: R=0 (“kouritsuka” matches)
number of concept nodes different between concept structures: X′=4 (“honyaku” and “sagyou” in the concept structure of the original text candidate 1, and “honyaku gyoumu” and “sore” in the concept structure of the reverse translated text 1)
number of node relationships that differ between concept structures: Y′=4 ([subject] between “kouritsuka” and “sagyou”, and [modifier] between “honyaku” and “sagyou” in the concept structure of the original text candidate 1, and [predicate object] between “kouritsuka” and “sore”, and [similarity] between “kikai honyaku” and “honyaku gyoumu” in the concept structure of the reverse translated text 1)
number of node attributes that differ between the concept structures: Z′=5 (<particle: wo>belonging to “sagyou”, and <attribute: collocation>belonging to “honyaku” in the concept structure of the original text candidate 1, and <termination: desu>belonging to “kouritsuka”, <termination: comma>belonging to “kikai honyaku”, and <particle: ha>belonging to “sore” in the concept structure of the reverse translated text 1)

$$Difference score between concept structures = α * R + β * {X}^{′} + γ * {Y}^{′} + δ * {Z}^{′} = 50 * 0 + 10 * 4 + 5 * 4 + 2 * 5 = 70$$

Then at step 1108, the degree of similarity computation section 222 uses the structure score computed at step 1104 and the difference score computed at step 1106 to compute the concept structure similarity of the original text candidate—reverse translated text pair acquired at step 1102. The concept structure similarity is computed as follows for the original text candidate 1—reverse translated text 1 pair as illustrated in FIG. 14 above.

$$Concept structure similarity = ( structure score of concept structures - difference score between concept structures ) / ( structure score of concept structures ) = ( 204 - 70 ) / 204 = 0.66$$

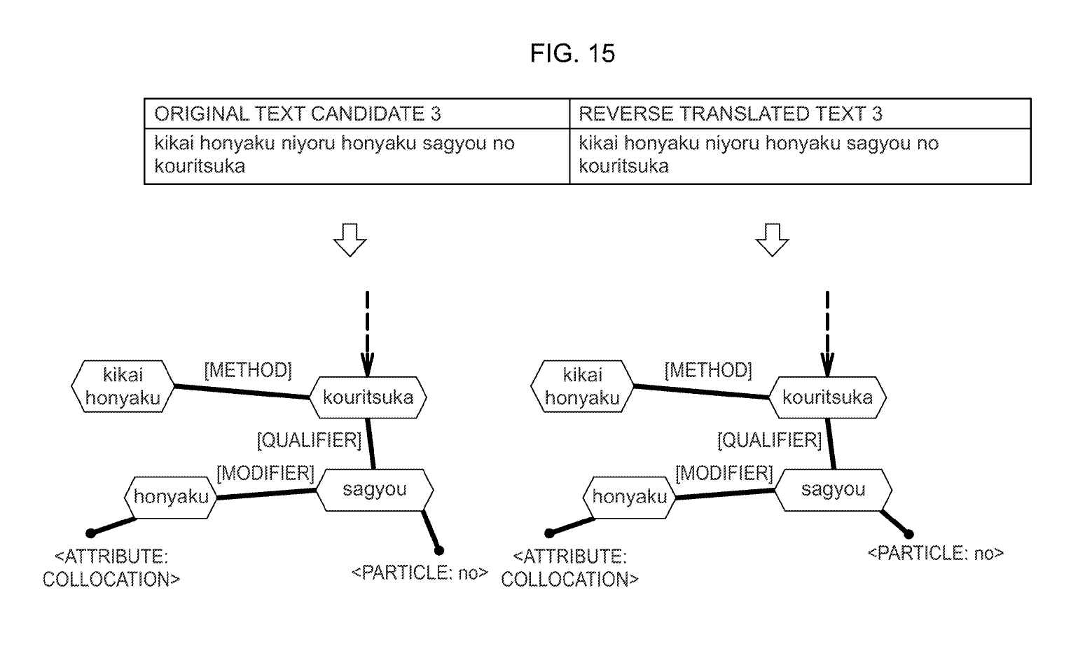

When, for example, the original text candidate—reverse translated text pair acquired at step 1102 is the original text candidate 3—reverse translated text 3 pair, the concept structure similarity between concept structures such as illustrated in FIG. 15 is computed. Computing the concept structure similarity between the original text candidate 3—reverse translated text 3 is performed as follows.
number of concept nodes other than the central concept included in the concept structure of the original text candidate 3: 3
number of concept nodes other than the central concept included in the concept structure of the reverse translated text 3: 3
number of concept nodes other than the central concept included in the both concept structures: X=6
number of node relationships included in the concept structure of the original text candidate 3: 3
number of node relationships included in the concept structure of the reverse translated text 3: 3
number of node relationships included in the both concept structures: Y=6
number of node attributes included in the concept structure of the original text candidate 3: 2
number of node attributes included in the concept structure of the reverse translated text 3: 2
number of node attributes included in the both concept structures: Z=4

$$structure score of concept structure = α * 2 + β * X + γ * Y + δ * Z = 50 * 2 + 10 * 6 + 5 * 6 + 2 * 4 = 206$$

difference of central concept between concept structures: R=0
number of concept nodes different between concept structures: X′=0
number of node relationships that differ between concept structures: Y′=0
number of node attributes that differ between the concept structures: Z′=0

$$difference score between concept structures = α * R + β * {X}^{′} + γ * {Y}^{′} + δ * {Z}^{′} = 50 * 0 + 10 * 0 + 5 * 0 + 2 * 0 = 0$$

$$Concept structure similarity = ( structure score of concept structures - difference score between concept ) / ( structure score of concept structures ) = ( 198 - 0 ) / 198 = 1.00$$

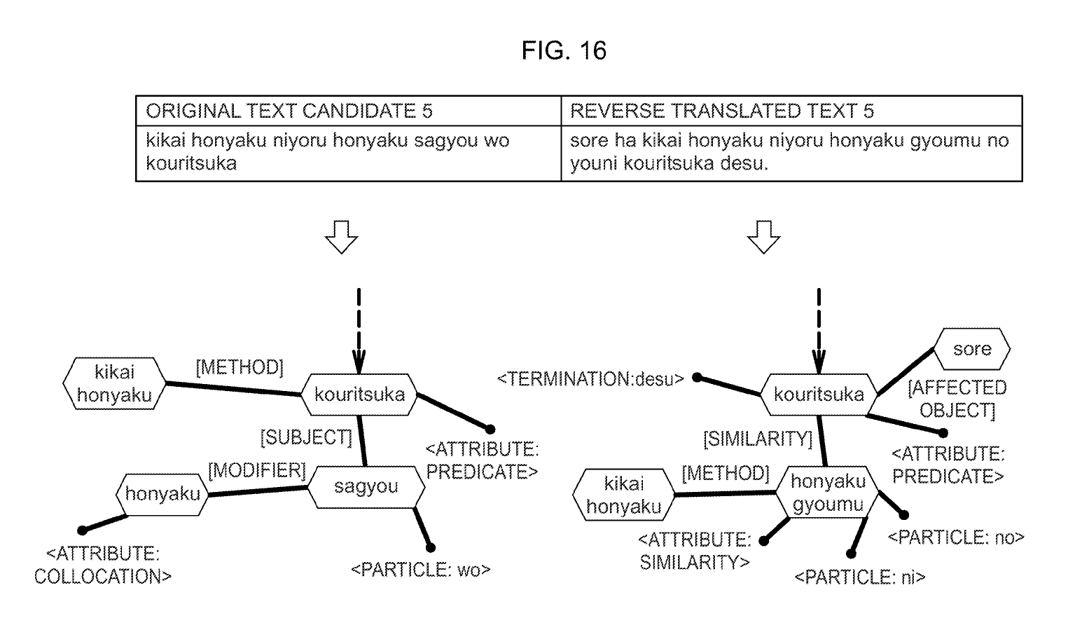

When, for example, the original text candidate—reverse translated text pair acquired at step 1102 is the original text candidate 5—reverse translated text 5 pair, the concept structure similarity between concept structures such as illustrated in FIG. 16 is computed. Computing the concept structure similarity between the original text candidate 5—reverse translated text 5 is performed as follows.
number of concept nodes other than the central concept included in the concept structure of the original text candidate 5: 3
number of concept nodes other than the central concept included in the concept structure of the reverse translated text 5: 3
number of concept nodes other than the central concept included in the both concept structures: X=6
number of node relationships included in the concept structure of the original text candidate 5: 3
number of node relationships included in the concept structure of the reverse translated text 5: 3
number of node relationships included in the both concept structures: Y=6
number of node attributes included in the concept structure of the original text candidate 5: 3
number of node attributes included in the concept structure of the reverse translated text 5: 5
number of node attributes included in the both concept structures: Z=8

$$structure score of concept structure = α * 2 + β * X + γ * Y + δ * Z = 50 * 2 + 10 * 6 + 5 * 6 + 2 * 8 = 206$$

difference of central concept between concept structures: R=0
number of concept nodes different between concept structures: X′=4
number of node relationships that differ between concept structures: Y′=6
number of node attributes that differ between the concept structures: Z′=6

$$difference score between concept structures = α * R + β * {X}^{′} + γ * {Y}^{′} + δ * {Z}^{′} = 50 * 0 + 10 * 4 + 5 * 6 + 2 * 6 = 82$$

$$Concept structure similarity = ( structure score of concept structures - difference score between concept structures ) / ( structure score of concept structures ) = ( 206 - 82 ) / 206 = 0.60$$

Then at step 1110, the appropriateness determination section 224 computes the notation similarity that is the degree of similarity between the notation of the original text candidate and the notation of the translated text candidate for the original text candidate—reverse translated text pair acquired at step 1102.

Then at step 1112, the appropriateness determination section 224 determines whether or not the notation similarity computed at step 1110 is higher than a predetermined threshold value. Processing proceeds to step 1114 when the notation similarity is higher than the threshold value, and the appropriateness determination section 224 outputs an appropriateness determination result of “OK”. However, processing proceeds to step 1116 when the notation similarity is the threshold value or lower, and the appropriateness determination section 224 outputs an appropriateness determination result of “NG”.

Then at step 118, the translated text candidate selection section 226 determines whether or not processing to compute the concept structure similarity and determine the appropriateness has been completed for all the original text candidate—reverse translated text pairs included in the pair list created at step 1100. Processing returns to step 1102 when there is still an un-processed pair present, the next pair is acquired from the pair list, and the processing of steps 1104 to 1116 is repeated. Processing proceeds to step 1120 when processing has been completed for all of the pairs.

At step 1120, based on the concept structure similarities computed at step 1110 and the appropriateness determination results output at step 1114 or step 1116, the translated text candidate selection section 226 selects the best translated text candidate from out of plural translated text candidates. For example, based on the concept structure similarities and the appropriateness determination results as illustrated in FIG. 10, out of the translated text candidates with “OK” appropriateness, the translated text candidate corresponding to the original text candidate—reverse translated text pair with the greatest concept structure similarity may be selected. After the translated text candidate selection section 226 has selected the translated text candidate, processing returns to the translation processing (FIG. 12).

Processing returns to step 112 of the translation processing illustrated in FIG. 12, the translation result output section 24 outputs as the translation result for the original text the translated text candidate selected at step 110, and the translation processing is ended.

As explained above, according to the translation device 10 according to the first exemplary embodiment, plural determined pre-editing rules or combination rules are applied and plural original text candidates generated, without the need for knowledge of the languages or of machine translation, and without considering the influence of pre-editing on the translation. Then the degrees of similarity between the concept structures of the original text candidates and the concept structures of the reverse translated texts corresponding to the respective original text candidates are computed. A high degree of similarity indicates that the concept structure is maintained between the original text candidate and the reverse translation text with a good quality corresponding translated text candidate, namely indicating that the pre-editing performed on the original text candidate was effective. This accordingly enables pre-editing that is effective in raising the translation quality to be selected without directly determining the effectiveness of the pre-editing performed on the original text. Difficulties in generating and applying pre-editing rules are accordingly eliminated, enabling translation quality to be raised.

Moreover, the notation similarities between the original text candidate and the reverse translated text are employed to determine as the translation result the appropriateness of translated text candidate for selection, enabling the translation quality to be maintained.

Moreover, by computing the concept structure similarity using the number of elements contained in each of the concept structures and the differences in the number of elements between concept structures, the concept structure similarities may be computed using a simple computation. Moreover, computing a concept structure similarity weighted according to the type of concept structure element enables a concept structure similarity to be computed in a manner that is flexible according to the purpose, by emphasizing maintaining the meaning of for example important portions of a sentence, or emphasizing maintaining the overall meaning.

Moreover, pre-editing rules may be created with all sorts of pre-editing rules that do not consider such factors as word order and grammar. Thus when an original text is input with mistakes in word order or grammar, there is a high probability of generating an original text candidate in which the word order or grammar mistake has been corrected through application of the pre-editing rules. For example, there is a mistake in part of the grammar of the original text illustrated in FIG. 2 “kikai honyaku niyori honyaku sagyou wo kouritsuka”. In this situation, the translation device 10 of the present exemplary embodiment selects the original text candidate 3 as the best original text candidate from the plural original text candidates. In the original text candidate 3, the grammar mistake contained in the original text has been eliminated. Outputting as the translation result the translated text candidate 3 corresponding to the original text candidate 3 effectively results in pre-editing being applied to the input original text that corrects the grammar of the original text. Thus according to the translation device according to the present exemplary embodiment, correction is performed on the original text automatically even when there are word order or grammar mistakes in the input original text, thereby enabling an accurate translation result to be derived.

### Second Exemplary Embodiment

Explanation next follows regarding a second exemplary embodiment. As illustrated in FIG. 17, a translation device 210 according to the second exemplary embodiment is configured with the addition of a pre-editing rule determination section 26 to the translation device 10 according to the first exemplary embodiment, and hence explanation follows regarding the pre-editing rule determination section 26.

In the translation device 210 according to the second exemplary embodiment, similarly to the translation device 10 according to the first exemplary embodiment, it is possible to create all sorts of pre-editing rules; however when there are too many pre-editing rules, the translation computation cost becomes much higher. There is the possibility that when pre-editing is performed on the original text, there are pre-editing rules present that generate original text candidates that are grammatically wrong. For example, there are grammatical mistakes contained in the original text candidate 4 and the original text candidate 8 illustrated in FIG. 4. It is seen from original text candidate 4 and original text candidate 8 that an original text candidate is created containing grammatical mistakes such as “honyaku sagyou no kouritsuka sura” as a result of application of the combination rule containing the rule 4 and the rule 5 of the pre-editing rules illustrated in FIG. 3. Such original text candidates containing grammatical mistakes give a low concept structure similarity computed by the degree of similarity computation section 222 illustrated in FIG. 10. This namely enables the inappropriateness of the rule combination containing the rule 4 and the rule 5 to be determined using the concept structure similarity.

Based on the concept structure similarity computed by the degree of similarity computation section 222, the pre-editing rule determination section 26 then determines which pre-editing rules or rule combinations are inappropriate for application to the original text. The pre-editing rule determination section 26 also updates the pre-editing rule DB 30 such that pre-editing rules or rule combinations determined to be inappropriate are not subsequently applied during processing.

More specifically, when the concept structure similarity computed for the original text candidate—reverse translated text pair is lower than the predetermined threshold value, the pre-editing rule determination section 26 determines the pre-editing rules or rule combinations applied to the original text during generation of this particular original text candidate to be inappropriate. For any pre-editing rules that the pre-editing rule determination section 26 has determined during plural repeated executions of the translation processing to be inappropriate a number of times that is a predetermined number of times or greater, the pre-editing rule determination section 26 deletes these pre-editing rules from the pre-editing rule DB 30. The pre-editing rule determination section 26 also flags any combination rules in the pre-editing rule DB 30 that have been determined to be inappropriate the number of times that is the predetermined number of times or greater, such that these combination rules are not subsequently employed in processing.

The translation device 210 may be implemented by a computer 40, such as for example that illustrated in FIG. 11. The computer 40 includes a CPU 42, a memory 44, a storage section 46, an input-output I/F 47, and a network I/F 48. The CPU 42, the memory 44, the storage section 46, the input-output I/F 47, and the network I/F 48 are connected together through a bus 49.

The storage section 46 that serves as a storage medium may be implemented for example by a Hard Disk Drive (HDD) or a flash memory. A translation program 250 to make the computer 40 function as the translation device 210 is stored in the storage section 46. The CPU 42 reads the translation program 250 from the storage section 46, expands the translation program 250 into the memory 44, and sequentially executes processes of the translation program 250.

The translation program 250 includes an original text input process 52, a language analyzing process 54, an original text candidate generating process 56, a machine translation process 58, a concept structure generation process 60, a selection process 62, a translation result output process 64, and a pre-editing rule determination process 66.

The CPU 42 operates as the pre-editing rule determination section 26 illustrated in FIG. 17 by executing the pre-editing rule determination process 66. Other processes are similar to those of the translation program 50 of the first exemplary embodiment. The computer 40 executing the translation program 250 accordingly functions as the translation device 210.

Note that it is possible to implement the translation device 210 with, for example, a semiconductor integrated circuit, and more particularly with an ASIC or the like.

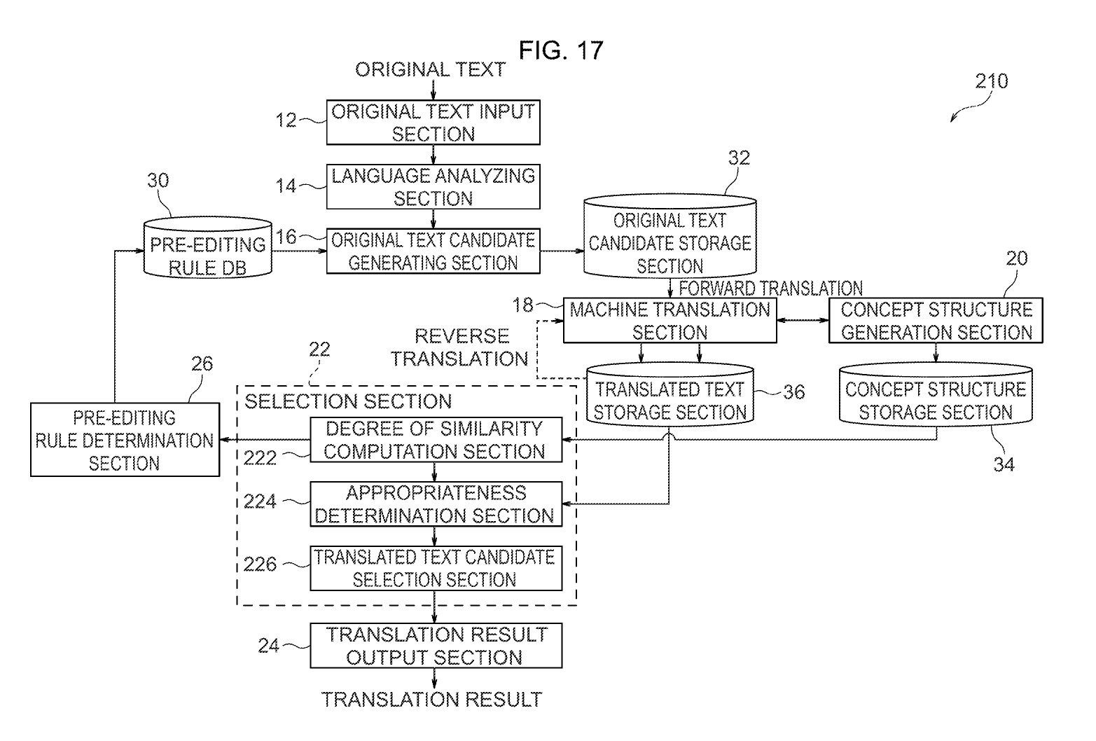

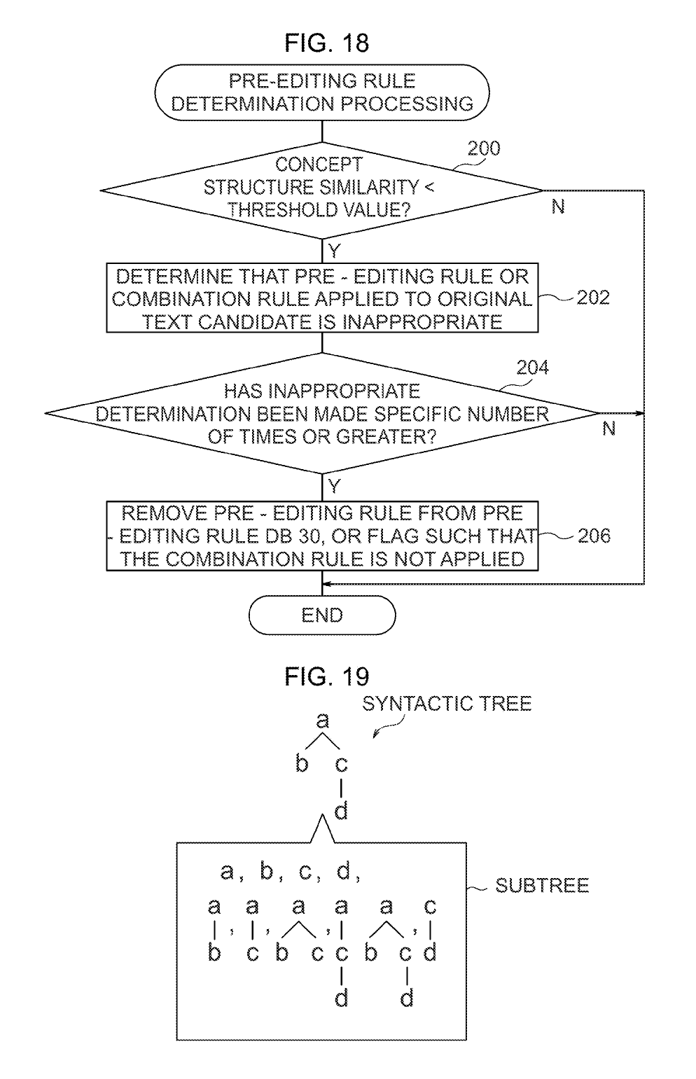

Explanation next follows regarding operation of the translation device 210 according to the second exemplary embodiment. On input of the original text to the translation device 210, similar translation processing and selection processing is executed by the translation device 210 to that of the translation processing (FIG. 12) and the selection processing (FIG. 13) illustrated for the first exemplary embodiment. When the concept structure similarity has been computed at step 1108 of the selection processing, then the pre-editing rule determination processing illustrated in FIG. 18 is executed in the translation device 210.

At step 200 of the pre-editing rule determination processing illustrated in FIG. 18, the pre-editing rule determination section 26 determines whether or not the concept structure similarity computed at step 1108 is lower than a predetermined threshold value. Processing proceeds to step 202 when the concept structure similarity is lower than the threshold value, and processing is ended when the concept structure similarity is the threshold value or greater.

At step 202, the pre-editing rule determination section 26 determines as inappropriate the pre-editing rule or rule combination that was applied to the original text during generation of the original text candidate—reverse translated text pair for which the concept structure similarity was computed at step 1108. The pre-editing rule determination section 26 then stores this determination result in a specific storage region.

Then at step 204, the pre-editing rule determination section 26 determines, for the pre-editing rule or rule combination that was determined to be inappropriate at step 202, whether or not the number of times determined inappropriate has reached the specific number of times or greater by reference to the determination results stored in the specific storage region. Processing proceeds to step 206 when the number of times determined inappropriate has reached the specific number or greater, and processing is ended when it is still less than the specific number of times.

At step 206, the pre-editing rule determination section 26 removes the pre-editing rule determined to be inappropriate the specific number of times or greater from the pre-editing rule DB 30. Otherwise, the pre-editing rule determination section 26 flags the pre-editing rule DB 30 such that rule combination determined to be inappropriate the specific number of times or greater is not applied in subsequent processing, and then the pre-editing rule determination processing is ended.

As explained above, according to the translation device 210 of the second exemplary embodiment, the effectiveness of application of the pre-editing rule or rule combination is determined based on the concept structure similarity. Thus, even though all sorts of plural pre-editing rules are created, updating is enabled such that pre-editing rules or rule combinations that are inappropriate during translation processing are automatically removed or rendered non-applicable for subsequent processing. This thereby enables the computation cost during translation processing to be suppressed from becoming too large while enabling difficulty in creating pre-editing rules to be eliminated.

Note that although explanation has been given in the second exemplary embodiment of a case in which it is determined that pre-editing rules or rule combinations with a concept structure similarity less than the threshold value are inappropriate, there is no limitation thereto. For example, configuration may be made to employ the fact that when the concept structure similarity of a particular original text candidate—reverse translated text pair is low, the translated text candidate corresponding to that original text candidate is not selected by the translated text candidate selection section 226. Specifically, pre-editing rules or rule combinations that are applied during generation of original text candidates corresponding to those translated text candidates that are not selected by the translated text candidate selection section 226 may be determined to be inappropriate.

Moreover in the second exemplary embodiment, updating of the pre-editing rules may be performed by each user when input is received from plural users. Specifically, a pre-editing rule DB 30 may be stored for each user, and statistics collated in the pre-editing rule determination section 26 by user for any pre-editing rules or rule combinations determined to be inappropriate. Then the pre-editing rule DB 30 by user may be updated based on the pre-editing rules or rule combinations determined to be inappropriate collated by each user. Adopting this approach enables the pre-editing rule DB 30 to be updated according to such factors as the characteristics and tendencies for grammar mistakes in the input of each of the users.

Although explanation has been given in each of the above exemplary embodiments of cases in which a degree of similarity based on the numbers and differences of each of the elements (central concept, concept nodes, node relationships, and node attributes) contained in the concept structure is computed as the concept structure similarity, there is no limitation thereto. For example, in consideration of the fact that the concept structure similarity is similar to the degree of similarity between tree structures or between graphs in natural language processing or other information science fields, the following similarities may be employed (reference document Tetsuro Takahashi, Kentaro Inui, Yuji Matsumoto “Methods for Estimating Syntactic Similarity”, Graduate School of Information Science Research Report, natural language processing research group report, July 2002, No. 66, pp. 163-170). Note that in such cases, the concept structure is viewed as a tree structure having the concept node corresponding to the central concept as the highest node, and with the node relationships that connect between concept nodes as edges.

For example, as the concept structure similarity, a similarity based on the edit distance of the tree structure may be computed. Specifically, edit distance that is the smallest number of editing operations to convert one concept structure into the other concept structure may be taken as the similarity. In such cases, smaller edit distances indicate greater similarity between concept structures.

Moreover, configuration may be made such that a tree structure alignment method is employed to compute the concept structure similarity. Cross-checking between texts is employed for alignment tasks. For example, for two concept structures, first correspondences of concept nodes are acquired, then using the correspondences of the concept nodes, similar regions in the concept structures are detected by cross-checking while acquiring the node relationships and node attributes. Configuration may also be made such that the similarity between the concept nodes that are the highest level nodes, equivalent to the central concepts, is computed whilst recursively computing the similarity between child nodes of each of the nodes.

As the concept structure similarity, the similarity may also be computed by employing a Tree Kernel, that is a method proposed to attribute similarities between phrase structure trees. In a Tree Kernel method, the inner product between phrase structure trees is defined as the number of common subtrees contained in each of the phrase structure trees. For example, the subtrees illustrated in the bottom row of FIG. 19 are contained in the syntactic structure trees as illustrated in the top row of FIG. 19. The number of common subtrees (a concept node or plural concept nodes connected by a node relationship) contained in two syntactic trees (concept structures) is the inner product. The inner product derived in this manner may be employed as a proxy for a degree of similarity that considers the syntactic tree as a whole, and may hence be employed as the concept structure similarity.

Note that the computation of the concept structure similarity is based on the number of and differences between each element described in the above exemplary embodiments enables the computation cost to be suppressed in comparison to computation of a degree of similarity based on the tree structure as described above.

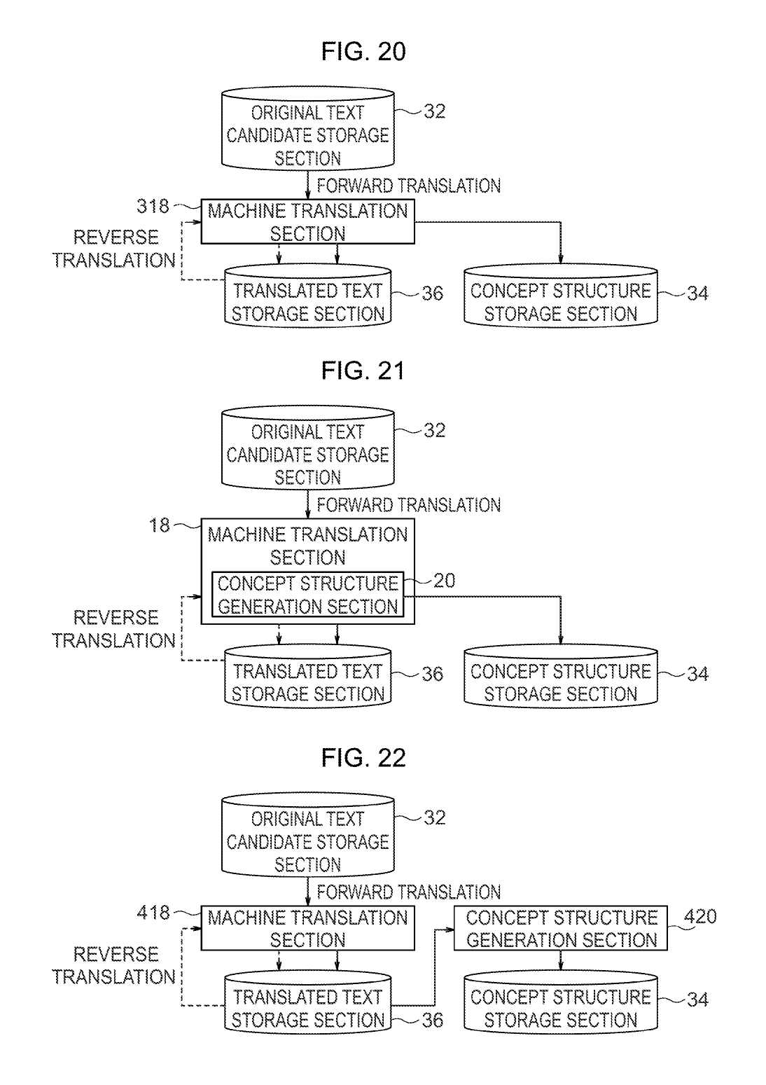

Moreover, although in each of the exemplary embodiments the machine translation section 18 and the concept structure generation section 20 are represented by separate functional blocks, in a translation device that employs concept structures, the concept structures are generated within a single chain of processing. Thus a machine translation section 318 that also performs concept structure generation may be employed, as illustrated in FIG. 20. Moreover, the configuration illustrated in FIG. 20 may also be represented as a configuration in which a machine translation section 18 contains the concept structure generation section 20, as illustrated in FIG. 21.

As illustrated in FIG. 22, a configuration with independent configurations for a machine translation section 418 and a concept structure generation section 420 may also be employed. In such cases, the machine translation section 418 performs translation processing without employing a concept structure generated by the concept structure generation section 420. For example, translation processing may be performed using a method that does not employ concept structure, or translation processing may be performed employing a concept structure generated by the machine translation section 418 itself. The concept structure generation section 420 also generates concept structures of each of the original text candidates stored in the original text candidate storage section 32 and generates concept structures of reverse translated texts for each of the reverse translated texts stored in the translated text storage section 36.

Note that FIG. 20 to FIG. 22 are block diagrams in which only a partial configuration of the translation device, including the machine translation section and the concept structure generation section, is depicted.

Moreover, explanation has been given in each of the above exemplary embodiments of cases in which the first language is Japanese and the second language is English, however there is no limitation thereto. Since the concept structure employed in technology disclosed herein is non-language dependent, technology disclosed herein is applicable to any language that is capable of being expressed by a concept structure.

Moreover, explanation has been given in each of the above exemplary embodiments of cases in which the original text is input as text data, however input may be made by audio data. Moreover, the translation results may also be output as audio data. In such cases configuration may be made to include a speech recognition section that performs speech recognition on the input audio data, and a speed synthesis section for speech output of the translation results.

Moreover, explanation has been given above of examples of technology disclosed herein in which the translation programs 50 and 250 that are examples of translation programs are pre-stored (installed) on the storage section 46. However, it is possible to provide the translation program of technology disclosed herein in a format stored on a recording medium such as a CD-ROM or DVD-ROM.

An aspect of the technology disclosed herein enables difficulty in creating and applying pre-editing rules to be removed, and enables translation quality to be improved.

All examples and conditional language provided herein are intended for the pedagogical purposes of aiding the reader in understanding the invention and the concepts contributed by the inventor to further the art, and are not to be construed as limitations to such specifically recited examples and conditions, nor does the organization of such examples in the specification relate to a showing of the superiority and inferiority of the invention. Although one or more embodiments of the present invention have been described in detail, it should be understood that the various changes, substitutions, and alterations could be made hereto without departing from the spirit and scope of the invention.

What is claimed is:

1. A translation device comprising:
a processor; and
a memory storing instructions that, when executed by the processor, perform a procedure, the procedure including:
generating a plurality of original text candidates by applying each of a plurality of predetermined different pre-editing rules, or rule combinations that are combinations of the pre-editing rules, to an original text expressed in a first language;
translating each of the plurality of original text candidates into respective translated text candidates expressed in a second language different from the first language, and translating each of the translated text candidates into a respective reverse translated text expressed in the first language; and
generating a concept structure expressing a semantic structure of each of the original text candidates and each of the reverse translation texts, and selecting a translated text candidate that corresponds to the original text candidate whose degree of similarity between the concept structure of the original text candidate and the concept structure of the reverse translated text corresponding to the original text candidate is a specific value or greater.

2. The translation device of claim 1, wherein:
when each of the translated text candidates is translated into the respective reverse translation text, each of the plurality of original text candidates is translated into the respective translated text candidate by employing the respective concept structure of each of the original text candidates, and each of the translated text candidates is translated into each of the reverse translated texts by employing the concept structure of the respective reverse translated text.

3. The translation device of claim 1, wherein:
the concept structure includes a plurality of different types of element; and
as the degree of similarity, the number of elements of each of the types included in the concept structure of the respective original text candidate and the concept structure of the respective reverse translated text, and the number of elements of each of the types that differ between the concept structure of the respective original text candidate and the concept structure of the respective reverse translated text, are employed to compute the degree of similarity of the concept structures.

4. The translation device of claim 3, wherein the degree of similarity of concept structures weighted according to the element type is computed as the degree of similarity.

5. The translation device of claim 1, wherein the procedure further comprises:
determining appropriateness of the pre-editing rule or the rule combination that was applied to the original text to generate the original text candidate based on the degree of similarity of the concept structures.

6. The translation device of claim 1, wherein the procedure further comprises:
when selecting a translated text candidate corresponding to the original text candidate, determining appropriateness of a translated text candidate as a translation result based on a degree of similarity between notation of the original text candidate and notation of the reverse translated text corresponding to the original text candidate.

7. A translation method that causes a computer to execute processing, the processing comprising:
generating a plurality of original text candidates by applying each of a plurality of predetermined different pre-editing rules or rule combinations that are combinations of the pre-editing rules to an original text expressed in a first language;
translating each of the plurality of original text candidates into respective translated text candidates expressed in a second language different from the first language, and translating each of the translated text candidates into a respective reverse translated text expressed in the first language; and
generating a concept structure expressing a semantic structure of each of the original text candidates and each of the reverse translation texts, and selecting a translated text candidate with the greatest degree of similarity between the concept structure of the original text candidate and the concept structure of the reverse translated text corresponding to the original text candidate as a default translation.

8. The translation method of claim 7, wherein:
when each of the translated text candidates is translated into the respective reverse translation text, each of the plurality of original text candidates is translated into the respective translated text candidate by employing the respective concept structure of each of the original text candidates, and each of the translated text candidates is translated into each of the reverse translated texts by employing the concept structure of the respective reverse translated text.

9. The translation method of claim 7, wherein:
the concept structure includes a plurality of different types of element; and
as the degree of similarity, the number of elements of each of the types included in the concept structure of the respective original text candidate and the concept structure of the respective reverse translated text, and the number of elements of each of the types that differ between the concept structure of the respective original text candidate and the concept structure of the respective reverse translated text, are employed to compute the degree of similarity of the concept structures.

10. The translation method of claim 9, wherein the degree of similarity of concept structures weighted according to the element type is computed as the degree of similarity.

11. The translation method of claim 7, wherein the method further comprises:
determining appropriateness of the pre-editing rule or the rule combination that was applied to the original text to generate the original text candidate based on the degree of similarity of the concept structures.

12. The translation method of claim 7, wherein the method further comprises:
when selecting a translated text candidate corresponding to the original text candidate, determining appropriateness of a translated text candidate as a translation result based on a degree of similarity between notation of the original text candidate and notation of the reverse translated text corresponding to the original text candidate.

13. A computer-readable recording medium having stored therein a program for causing a computer to execute a translation process, the process comprising:
generating a plurality of original text candidates by applying each of a plurality of predetermined different pre-editing rules or rule combinations that are combinations of the pre-editing rules to an original text expressed in a first language;
translating each of the plurality of original text candidates into respective translated text candidates expressed in a second language different from the first language, and translating each of the translated text candidates into a respective reverse translated text expressed in the first language; and
generating a concept structure expressing a semantic structure of each of the original text candidates and each of the reverse translation texts, and selecting a translated text candidate with the greatest degree of similarity between the concept structure of the original text candidate and the concept structure of the reverse translated text corresponding to the original text candidate as a default translation.

14. The computer-readable recording medium of claim 13, wherein in the translation process:
when each of the translated text candidates is translated into the respective reverse translation text, each of the plurality of original text candidates is translated into the respective translated text candidate by employing the respective concept structure of each of the original text candidates, and each of the translated text candidates is translated into each of the reverse translated texts by employing the concept structure of the respective reverse translated text.

15. The computer-readable recording medium of claim 13, wherein in the translation process:
the concept structure includes a plurality of different types of element; and
as the degree of similarity, the number of elements of each of the types included in the concept structure of the respective original text candidate and the concept structure of the respective reverse translated text, and the number of elements of each of the types that differ between the concept structure of the respective original text candidate and the concept structure of the respective reverse translated text, are employed to compute the degree of similarity of the concept structures.

16. The computer-readable recording medium of claim 15, wherein in the translation process, the degree of similarity of concept structures weighted according to the element type is computed as the degree of similarity.

17. The computer-readable recording medium of claim 13, wherein the translation process further comprises:
determining appropriateness of the pre-editing rule or the rule combination that was applied to the original text to generate the original text candidate based on the degree of similarity of the concept structures.

18. The computer-readable recording medium of claim 13, wherein the translation process further comprises:
when selecting a translated text candidate corresponding to the original text candidate, determining appropriateness of a translated text candidate as a translation result based on a degree of similarity between notation of the original text candidate and notation of the reverse translated text corresponding to the original text candidate.
